(19) United States
(12) Patent Application Publication
(10) Pub. No.: US 2025/0349163 A1
(43) Pub. Date: Nov. 13, 2025

(54) METHOD AND DEVICE FOR PREDICTING VEHICLE MOTOR NOISE

(71) Applicants: HYUNDAI MOTOR COMPANY, Seoul (KR); Kia Corporation, Seoul (KR)

(72) Inventors: Tac-koon KIM, Hwaseong-si (KR); Buyeol RYU, Hwaseong-si (KR)

(21) Appl. No.: 18/956,140

(22) Filed: Nov. 22, 2024

(30) Foreign Application Priority Data
May 13, 2024 (KR) 10-2024-0062273

(51) Int. Cl. G07C 5/10; G01M 15/12; G06F 3/16

(52) U.S. Cl. CPC G07C 5/10; G01M 15/12; G06F 3/162

(57) ABSTRACT

A method and a device for predicting vehicle motor noise that predicts motor noise separated from vehicle noise are provided. The method may include acquiring motor noise data that does not include the vehicle noise; acquiring vehicle noise data that does not comprise the motor noise; generating training data by mixing the motor noise data and the vehicle noise data; providing a deep learning model built differently for each vehicle through transfer learning based on a pre-trained model that is pre-trained by the learning data; and predicting motor noise for each vehicle by using the deep learning model.

### CROSS-REFERENCE TO RELATED APPLICATION

This application claims priority to and the benefit of Korean Patent Application No. 10-2024-0062273 filed in the Korean Intellectual Property Office on May 13, 2024, the entire contents of which are incorporated herein by reference.

### TECHNICAL FIELD

The disclosure relates to a method and a device for predicting vehicle motor noise.

### BACKGROUND

In the automotive industry, vehicle components can be diagnosed by capturing and analyzing noise data specific to each part. For instance, in the case of a vehicle motor, analyzing generated noise allows for evaluating the motor's condition and predicting potential issues. Abnormal motor noise may indicate various defects, such as bearing damage, rotor imbalance, stator-rotor friction, or coil short circuits, which can be identified by examining specific noise patterns and frequencies. Regular noise monitoring also enables tracking motor wear and estimating remaining lifespan. Additionally, noise data can assist in performance optimization by identifying factors affecting motor efficiency and adjusting operating conditions accordingly. To enhance diagnostic accuracy and effectiveness, it is essential to capture noise data from individual components, excluding general vehicle noise.

### SUMMARY

The present disclosure is directed to a method and a device for predicting vehicle motor noise by isolating and capturing motor-specific noise, separate from general vehicle noise.

According to an aspect of the present disclosure, a method of predicting vehicle motor noise can include acquiring motor noise data that does not include vehicle noise; acquiring vehicle noise data that does not include the motor noise; generating training data by mixing the motor noise data and the vehicle noise data; providing a deep learning model built differently for each vehicle through transfer learning based on a pre-trained model that is pre-trained by the training data; and predicting motor noise for each vehicle by using the deep learning model.

In some implementations, the generating of the training data can include mixing the motor noise data and the vehicle noise data by using a Signal to Noise Ratio (SNR) value calculated with respect to the motor noise and the vehicle noise.

In some implementations, the mixing can include acquiring motor noise amplification data by multiplying the motor noise data by the SNR value; and mixing the motor noise amplification data and the vehicle noise data.

In some implementations, the pre-trained model can include a time domain-based audio source separation model.

In some implementations, the pre-trained model can include an encoder including one-dimensional (1-D) convolution layer; a separation network including a deep convolution layer; and a decoder including 1-D transposed convolution layer.

In some implementations, a loss function of the deep learning model can include a scale-invariant signal-to-distortion ratio (SI-SDR).

In some implementations, the loss function can be defined by Equation 1 below:

$$S D R = 10 {log}_{10} ( \frac{{‖ {S}_{target} ‖}^{2}}{{‖ {S}_{target} - {\hat{S}}_{i} ‖}^{2}} ) \qquad ( Equation 1 )$$

wherein S_{target} is a target value, and Ŝᵢ is an output value of the deep learning model.

In some implementations, a performance index of the deep learning model can include a scale-invariant signal-to-distortion ratio improvement (SI-SDRi).

In some implementations, the providing of the deep learning model can include providing a first deep learning model to which a first new layer specialized for a first vehicle type is added through the pre-trained model-based transfer learning, and the predicting of the motor noise can include predicting the motor noise of a vehicle corresponding to the first vehicle type by using the first deep learning model.

In some implementations, the providing of the deep learning model can further include providing a second deep learning model to which a second new layer specialized for a second vehicle type different from the first vehicle type is added through the pre-trained model-based transfer learning, and the predicting of the motor noise can further include predicting the motor noise of a vehicle corresponding to the second vehicle type by using the second deep learning model.

According to another aspect of the present disclosure, a device for predicting vehicle motor noise that executes program codes loaded on one or more memory devices through one or more processors and predicts motor noise separated from vehicle noise, wherein the program codes can be executed to acquire motor noise data that does not include the vehicle noise, acquire vehicle noise data that does not include the motor noise, generate training data by mixing the motor noise data and the vehicle noise data, provide a deep learning model built differently for each vehicle through transfer learning based on a pre-trained model that is pre-trained by the training data, and predict motor noise for each vehicle by using the deep learning model.

In some implementations, the generating of the training data can include mixing the motor noise data and the vehicle noise data by using a Signal to Noise Ratio (SNR) value calculated with respect to the motor noise and the vehicle noise.

In some implementations, the mixing can include acquiring motor noise amplification data by multiplying the motor noise data by the SNR value, and mixing the motor noise amplification data and the vehicle noise data.

In some implementations, the pre-trained model can include a time domain-based audio source separation model.

In some implementations, the pre-trained model can include an encoder including a one-dimensional (1-D) convolution layer; a separation network including a deep convolution layer; and a decoder including a 1-D transposed convolution layer.

In some implementations, a loss function of the deep learning model can include a scale-invariant signal-to-distortion ratio (SI-SDR). In some implementations, the loss function can be defined by Equation 1 below:

$$S D R = 10 {log}_{10} ( \frac{{‖ {S}_{target} ‖}^{2}}{{‖ {S}_{target} - {\hat{S}}_{i} ‖}^{2}} ) \qquad ( Equation 1 )$$

wherein S_{target} is a target value, and Ŝᵢ is an output value of the deep learning model.

In some implementations, a performance index of the deep learning model can include a scale-invariant signal-to-distortion ratio improvement (SI-SDRi).

In some implementations, the providing of the deep learning model can include providing a first deep learning model to which a first new layer specialized for a first vehicle type is added through the pre-trained model-based transfer learning, and the predicting of the motor noise can include predicting the motor noise of a vehicle corresponding to the first vehicle type by using the first deep learning model.

In some implementations, the providing of the deep learning model can further include a second deep learning model to which a second new layer specialized for a second vehicle type different from the first vehicle type is added through the pre-trained model-based transfer learning, and the predicting of the motor noise can further include predicting the motor noise of a vehicle corresponding to the second vehicle type by using the second deep learning model.

### BRIEF DESCRIPTION OF THE DRAWINGS

FIG. 1 is a block diagram illustrating an example of a device for predicting vehicle motor noise.

FIG. 2 is a flowchart illustrating an example of a method of predicting vehicle motor noise.

FIG. 3 is a diagram illustrating an example of a device and a method for predicting vehicle motor noise.

FIGS. 4 to 6 are diagrams illustrating an example of a device and a method for predicting vehicle motor noise.

FIG. 7 is a diagram illustrating an example of a device and a method for predicting vehicle motor noise.

FIG. 8 is a diagram illustrating an example of a computing device.

### DETAILED DESCRIPTION

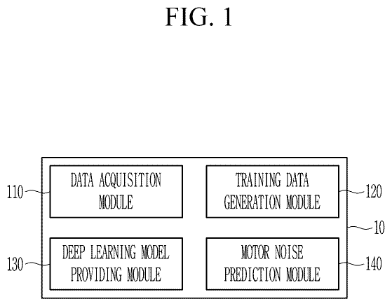

FIG. 1 is a block diagram illustrating an example of a device for predicting vehicle motor noise.

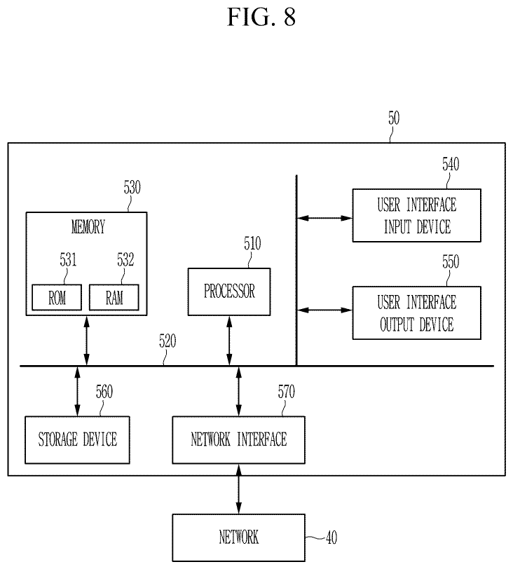

Referring to FIG. 1, a device 10 for predicting vehicle motor noise can execute program codes loaded on one or more memory devices through one or more processors. For example, the device 10 for predicting the vehicle motor noise can be implemented as a computing device 50 as described below with reference to FIG. 8. In some implementations, the one or more processors can correspond to a processor 510 of the computing device 50, and the one or more memory devices can correspond to a memory 530 of the computing device 50. The program codes can be executed by the one or more processors to acquire only motor-specific noise separated from general vehicle noise.

The device 10 for predicting the vehicle motor noise can include a data acquisition module 110, a training data generation module 120, a deep learning model providing module 130, and a motor noise prediction module 140, to thereby predict the motor-specific noise separated from general vehicle noise.

The data acquisition module 110 can acquire the motor-specific noise data that does not include the general vehicle noise. For example, the data acquisition module 110 can separately acquire motor-specific noise data to designate a label corresponding to an accurate correct answer when learning an artificial intelligence model. In some implementations, the motor-specific noise data can be acquired from a motor that operates separately in an anechoic chamber or by supplying separate power to the motor without starting the vehicle.

In some implementations, the data acquisition module 110 can acquire general vehicle noise data that does not include the motor-specific noise. For example, the data acquisition module 110 can separately acquire the general vehicle noise data for accurate values other than the label when learning the artificial intelligence model. In some implementations, the general vehicle noise data can be acquired from a vehicle operating with the motor shielded in the anechoic chamber.

The training data generation module 120 can generate training data by combining the motor-specific noise data with the general vehicle noise data acquired by the data acquisition module 110. In some implementations, the training data generation module 120 can calculate a signal to noise ratio (SNR) value with respect to the motor-specific noise data and the general vehicle noise data acquired by the data acquisition module 110, and combine the motor-specific noise data with the general vehicle noise data by using the calculated SNR value. SNR can be calculated as follows.

$${( S N R )}_{dB} = 10 {log}_{10} \frac{{P}_{signal}}{{P}_{noise}}$$

Here, P_{signal} can refer to power of a motor noise signal, and Pₙₒᵢₛₑ can refer to power of a vehicle noise signal. The power of the motor noise signal can refer to average power transmitted by the motor noise signal during a specific time, and the power of the vehicle noise signal can refer to average power of an unnecessary or extraneous signal generated during the transmission of the motor noise signal. The greater the SNR value, the better the quality of the motor noise signal can be evaluated.

The training data generation module 120 can acquire motor noise amplification data corresponding to a signal amplified by multiplying the motor noise data acquired by the data acquisition module 110 by the SNR value. Subsequently, the training data generation module 120 can combine the motor noise amplification data and the vehicle noise data. As described above, SNR-based combination can be performed, thereby preventing an overfitting problem that shows high accuracy with respect to the leaning data but deteriorates performance with respect to new data, and improving the accuracy of motor noise prediction.

The deep learning model providing module 130 can provide a deep learning model built differently for each vehicle, through transfer learning based on a pre-trained model that is pre-trained by the training data generated by the training data generation module 120.

Transfer learning is a methodology that leverages a model trained for one domain or task and applies it to another related or similar domain or task, utilizing a model that has undergone prior pre-training. Here, the model on which pre-training has been completed can refer to the pre-trained model that is pre-trained by the leaning data generated by the training data generation module 120.

In some implementations, the pre-trained model can include an audio source separation model based on a time domain. The pre-trained model can process an audio signal directly in the time domain other than a frequency domain, learn a pattern from a complex audio signal, and separate sources by using a deep convolutional neural network. For example, the pre-trained model can have a structure including an encoder, a separation network, and a decoder. The encoder can include a one-dimensional (1-D) convolution layer, and the separation network can include a deep convolution layer. In some implementations, the decoder can include a 1-D transposed convolution layer. The transposed convolution layer, also called deconvolution, can be used to expand a spatial dimension in a convolutional neural network. To this end, for example, a method of spatially inserting a value such as 0 between elements of input data can be adopted.

In some implementations, a loss function of a deep learning model can include a scale-invariant signal-to-distortion ratio (SI-SDR). SI-SDR can be a loss function for evaluating the quality of a signal in the field of audio and audio processing, and can evaluate the performance of a motor noise separation task by measuring a ratio between an original signal and an estimated signal. SI-SDR has scale invariance capable of accurately measuring a degree of distortion of a signal even when the scale of the estimated signal is different from that of the original signal, thereby processing various volume signals. The loss function can be defined by Equation 1 below.

$$S D R = 10 {log}_{10} ( \frac{{‖ {S}_{target} ‖}^{2}}{{‖ {S}_{target} - {\hat{S}}_{i} ‖}^{2}} ) \qquad ( Equation 1 )$$

Here, S_{target} can refer to a target value, and Ŝᵢ can refer to an output value of the deep learning model. Accordingly, S_{target}-Ŝᵢ can correspond to an error. The error can correspond to the sum of an interference signal e_{interf}, background noise eₙₒᵢₛₑ, and an artificial distortion e_{artif} that may occur during a processing process and can be minimized, and thus, quality can be improved.

The motor noise prediction module 140 can predict motor noise for each vehicle by using the deep learning model provided by the deep learning model providing module 130.

In some implementations, a performance index of the deep learning model can include a scale-invariant signal-to-distortion ratio improvement (SI-SDRi). In comparison with the original signal, SI-SDRi can indicate a degree of quality improvement of an output signal after a signal processing process related to separation of the motor-specific noise. For example, SI-SDRi can be calculated by subtracting an SDR value with respect to an input signal before processing from an SDR value for an output signal after processing, and it may be understood that the greater the value, the greater the quality improvement effect compared to the original signal.

In some implementations, only the motor-specific noise that is completely separated from the vehicle noise can be acquired, unlike the conventional systems in which there is a lack of reliability about whether a fast Fourier transform (FFT) peak value is correct due to the overlapping of vehicle noise and motor noise, and it is difficult to apply other analysis techniques except for checking the FFT peak. Accordingly, not only a noise representative value (e.g., a root mean square (RMS)) in a time domain can be analyzed, which was difficult in the conventional systems, but also it is possible to analyze a clear peak that is separated without being masked by other noise in a frequency domain, unlike the conventional systems in which analysis was performed with various types of noise overlapping in the frequency domain.

In some implementations, the deep learning model providing module 130 can provide deep learning models specialized for different vehicle types through pre-trained model-based transfer learning, and the motor noise prediction module 140 can predict motor-specific noise for each vehicle type by using each specialized deep learning model.

For example, the deep learning model providing module 130 can provide a first deep learning model to which a first new layer specialized for a first vehicle type is added through pre-trained model-based transfer learning. Here, the first new layer can refer to a layer for extracting a feature unique to the first vehicle type. In addition, the deep learning model providing module 130 can provide a second deep learning model in which a second new layer specialized for a second vehicle type different from the first vehicle type is added through pre-trained model-based transfer learning. Here, the second new layer can refer to a layer for extracting a feature unique to the second vehicle type. The motor noise prediction module 140 can predict motor-specific noise of a vehicle corresponding to the first vehicle type by using the first deep learning model, and predict motor-specific noise of a vehicle corresponding to the second vehicle type by using the second deep learning model.

In some implementations, Models may be distributed and applied to various derivative vehicles by implementing an objective and reliable platform that acquires only motor-specific noise from a reference vehicle model, thereby reducing the man hours, time, and cost required for motor noise analysis for each vehicle type.

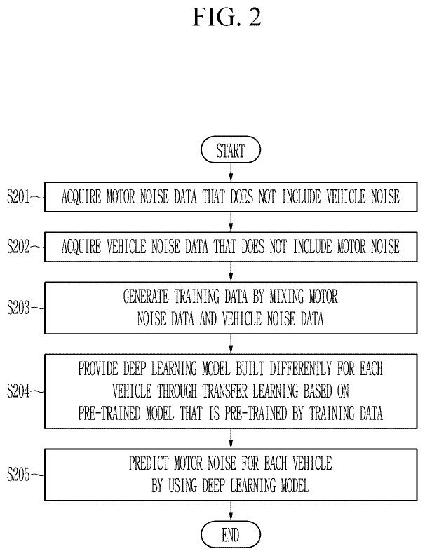

FIG. 2 is a flowchart illustrating an example of a method of predicting vehicle motor noise.

The method of predicting the vehicle motor noise can include acquiring motor noise data that does not include vehicle noise (S201), acquiring vehicle noise data that does not include the motor noise (S202), generating training data by combining the motor noise data and the vehicle noise data (S203), providing a deep learning model built differently for each vehicle through transfer learning based on a pre-trained model that is pre-trained by the training data (S204), and predicting motor-specific noise for each vehicle by using the deep learning model (S205).

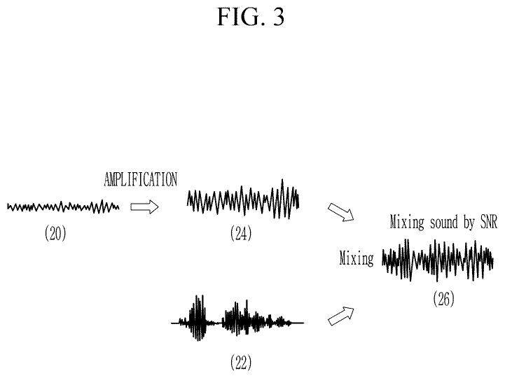

FIG. 3 is a diagram illustrating an example of a device and a method for predicting vehicle motor noise.

Referring to FIG. 3, in the implementation example of the device and the method for predicting the vehicle motor noise, training data 26 can be generated by combining motor noise data 20 and vehicle noise data 22. To this end, SNR values can be calculated with respect to the motor noise data 20 and the vehicle noise data 22, and motor noise amplification data 24 can be obtained by multiplying the calculated SNR value with respect to the motor noise data 20. Thereafter, training data 26 can be generated by combining the motor noise amplification data 24 and the vehicle noise data 22. For example, the motor noise data 20 can be acquired from a motor that operates separately in an anechoic chamber or can be acquired by applying separate power to a motor without starting a vehicle. In some implementations, the vehicle noise data 22 can be acquired from a vehicle operating with the motor shielded in the anechoic chamber.

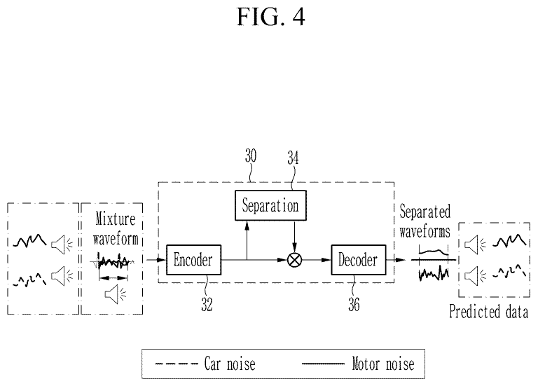

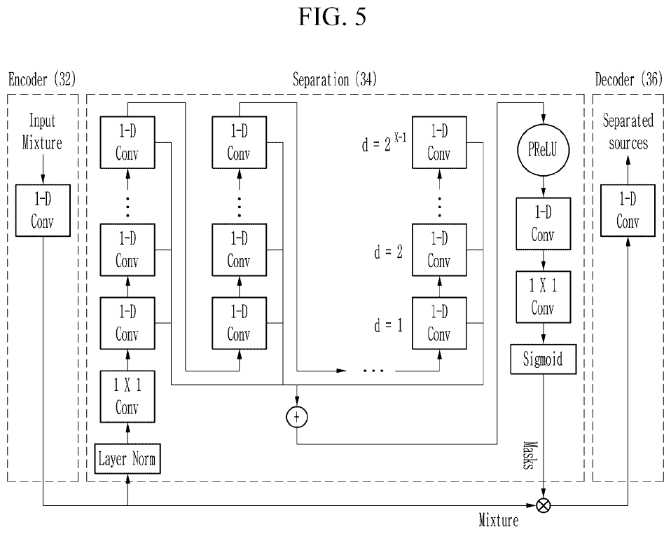

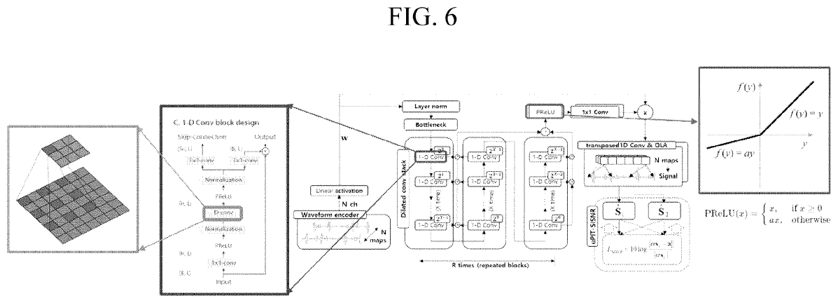

FIGS. 4 to 6 are diagrams illustrating an example of a device and a method for predicting vehicle motor noise.

Referring to FIGS. 4 to 6, as a non-limiting example of a pre-trained model that can be adopted as a time domain-based audio source separation model, an architecture of a convolutional time-domain audio separation network (Conv-TasNet) is illustrated. In some implementations, referring to FIG. 1, the deep learning model providing module 130 can provide a deep learning model built differently for each vehicle, through transfer learning based on Conv-TasNet that is pre-trained by training data generated by the training data generation module 120.

A pre-trained model 30 can include an encoder 32, a separation network 34, and a decoder 36. Waveforms in which a vehicle noise signal and a motor noise signal are combined can be input to the encoder 32, and the decoder 36 can output predicted data in which the vehicle noise signal and the motor noise signal are separated from each other. The encoder 32 and the decoder 36 can each include a 1-D convolution layer, and the separation network 34 can have a structure in which 1-D convolution layers with different dilation rates are stacked, and adopt PReLU as an activation function.

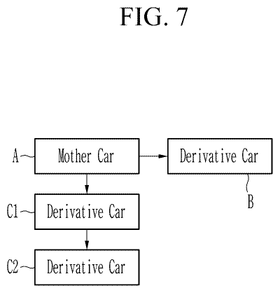

FIG. 7 is a diagram illustrating an example of a device and a method for predicting vehicle motor noise.

Referring to FIG. 7, in the example of the device and the method for predicting the vehicle motor noise, motor-specific noise for each vehicle type can be predicted by using deep learning models specialized for different vehicle types through pre-trained model-based transfer learning. For example, a deep learning model implemented in a reference car A can be provided to a first derivative car B and a second derivative car C1. At this time, a deep learning model in which a new layer specialized for the first derivative car B is added to the deep learning model implemented in the reference car A can be provided to the first derivative car B, and a deep learning model in which a new layer specialized for the second derivative car C1 is added to the deep learning model implemented in the reference car A can be provided to the second derivative car C1. In addition, a deep learning model implemented in the second derivative car C1 can be provided to a third derivative car C2. At this time, a deep learning model in which a new layer specialized for the third derivative car C2 is added to the deep learning model implemented in the second derivative car C1 can be provided to the third derivative car C2. Accordingly, models can be distributed and applied to the first to third derivative cars B, C1, and C2 by implementing an objective and reliable platform that acquires only motor-specific noise from the reference car A, thereby reducing the man hour, time, and cost required for motor noise analysis for each vehicle type.

FIG. 8 is a diagram illustrating an example of a computing device.

Referring to FIG. 8, a method and a device for predicting vehicle motor noise can be implemented by using the computing device 50.

The computing device 50 can include at least one of the processor 510, a memory 530, a user interface input device 540, a user interface output device 550, and a storage device 560 that communicate with each other over a bus 520. The computing device 50 can also include a network interface 570 that is electrically connected to a network 40. The network interface 570 can transmit or receive signals to and from other entities through the network 40.

The processor 510 can be implemented as a variety of types, such as a Micro Controller Unit (MCU), Application Processor (AP), Central Processing Unit (CPU), Graphic Processing Unit (GPU), Neural Processing Unit (NPU), and Quantum Processing Unit (QPU), and can be any semiconductor device that executes commands stored in the memory 530 or the storage device 560. The processor 510 may be configured to implement the functions and methods described above with respect to FIGS. 1 to 7.

The memory 530 and the storage device 560 can include various types of volatile or non-volatile storage media. For example, the memory 530 can include read-only memory (ROM) 531 and random access memory (RAM) 532. In some implementations, the memory 530 can be located inside or outside the processor 510, and the memory 530 can be connected to the processor 510 through various known means.

In some implementations, at least some components or functions of the method and the device for predicting the vehicle motor noise can be implemented in a program or software executed by the computing device 50, and the program or software can be stored in a computer-readable medium. Specifically, the computer-readable medium can record a program for executing steps included in the method and the device for predicting the vehicle motor noise, on a computer including the processor 510 that executes a program or command stored in the memory 530 or the storage device 560.

In some implementations, at least some components or functions of the method and device for predicting the vehicle motor noise can be implemented by using hardware or circuit of the computing device 50, or can be implemented as separate hardware or circuit that can be electrically connected to the computing device 50.

As described above, it is possible to acquire only the motor noise that is completely separated from the vehicle noise, unlike conventional systems in which there is a lack of reliability about whether a fast Fourier transform (FFT) peak value is correct due to the overlapping of vehicle noise and motor noise, and it is difficult to apply other analysis techniques except for checking the FFT peak. Accordingly, not only a noise representative value (e.g., an RMS) in a time domain can be analyzed, which was difficult in the conventional systems t, but also it is possible to analyze a clear peak that is separated without being masked by other noise in a frequency domain, unlike the conventional systems in which analysis was performed with various types of noise overlapping in the frequency domain. In addition, models can be distributed and applied to various derivative cars by implementing an objective and reliable platform that acquires only motor noise-specific from a reference car, thereby reducing the man hour, time, and cost required for motor noise analysis for each vehicle type.

What is claimed is:

1. A method of predicting vehicle motor noise, the method comprising:
acquiring motor noise data that comprises only motor-specific noise, excluding noise from other vehicle components;
acquiring vehicle noise data that comprises the noise from other components and that does not comprise the motor-specific noise;
generating training data by combining the motor noise data with the vehicle noise data;
providing a deep learning model built differently for each vehicle through transfer learning based on a pre-trained model that is pre-trained by the training data; and
predicting motor-specific noise for each vehicle based on the deep learning model.

2. The method of claim 1, wherein generating the training data includes:
combining the motor noise data and the vehicle noise data by using a signal to noise ratio (SNR) value calculated with respect to the motor-specific noise and the noise from other vehicle components.

3. The method of claim 2, wherein combining the motor noise data with the vehicle noise data comprises:
acquiring motor noise amplification data by multiplying the motor noise data by the SNR value, and
combining the motor noise amplification data with the vehicle noise data.

4. The method of claim 1, wherein:
the pre-trained model includes a time domain-based audio source separation model.

5. The method of claim 1, wherein the pre-trained model includes:
an encoder including a one-dimensional (1-D) convolution layer,
a separation network including a deep convolution layer, and
a decoder including 1-D transposed convolution layer.

6. The method of claim 5, wherein:
a loss function of the deep learning model includes a scale-invariant signal-to-distortion ratio (SI-SDR).

7. The method of claim 6, wherein:
the loss function is defined by the equation below:
$$S D R = 10 {log}_{10} ( \frac{{‖ {S}_{target} ‖}^{2}}{{‖ {S}_{target} - {\hat{S}}_{i} ‖}^{2}} )$$
wherein S_{target} is a target value, and Ŝᵢ is an output value of the deep learning model.

8. The method of claim 5, wherein:
a performance index of the deep learning model includes a scale-invariant signal-to-distortion ratio improvement (SI-SDRi).

9. The method of claim 1, wherein providing the deep learning model includes providing a first deep learning model to which a first new layer specialized for a first vehicle type is added through the pre-trained model-based transfer learning, and
wherein predicting the motor-specific noise includes predicting the motor-specific noise of a vehicle corresponding to the first vehicle type based on the first deep learning model.

10. The method of claim 9, wherein providing the deep learning model further includes providing a second deep learning model to which a second new layer specialized for a second vehicle type different from the first vehicle type is added through the pre-trained model-based transfer learning, and
wherein predicting the motor-specific noise further includes predicting the motor-specific noise of a vehicle corresponding to the second vehicle type based on the second deep learning model.

11. A device for predicting vehicle motor noise comprising:
one or more memory devices configured to store instructions; and
one or more processors configured to execute the instructions to perform operations comprising:
acquiring motor noise data that comprises only motor-specific noise, excluding noise from other vehicle components;
acquiring vehicle noise data that comprises the noise from other components and that does not comprise the motor-specific noise;
generating training data by combining the motor noise data with the vehicle noise data;
providing a deep learning model built differently for each vehicle through transfer learning based on a pre-trained model that is pre-trained by the training data; and
predicting motor-specific noise for each vehicle based on the deep learning model.

12. The device of claim 11, wherein generating the training data includes:
combining the motor noise data and the vehicle noise data by using a signal to noise ratio (SNR) value calculated with respect to the motor-specific noise and the noise from other vehicle components.

13. The device of claim 12, wherein combining the motor noise data with the vehicle noise data comprises:
acquiring motor noise amplification data by multiplying the motor noise data by the SNR value, and
combining the motor noise amplification data with the vehicle noise data.

14. The device of claim 11, wherein the pre-trained model includes a time domain-based audio source separation model.

15. The device of claim 11, wherein the pre-trained model includes:
an encoder including one-dimensional (1-D) convolution layer,
a separation network including a deep convolution layer, and
a decoder including a 1-D transposed convolution layer.

16. The device of claim 15, wherein a loss function of the deep learning model includes a scale-invariant signal-to-distortion ratio (SI-SDR).

17. The device of claim 16, wherein the loss function is defined by the equation below:
$$S D R = 10 {log}_{10} ( \frac{{‖ {S}_{target} ‖}^{2}}{{‖ {S}_{target} - {\hat{S}}_{i} ‖}^{2}} )$$
wherein S_{target} is a target value, and Ŝᵢ is an output value of the deep learning model.

18. The device of claim 15, wherein a performance index of the deep learning model includes a scale-invariant signal-to-distortion ratio improvement (SI-SDRi).

19. The device of claim 11, wherein providing the deep learning model includes providing a first deep learning model to which a first new layer specialized for a first vehicle type is added through the pre-trained model-based transfer learning, and
wherein predicting the motor-specific noise includes predicting the motor-specific noise of a vehicle corresponding to the first vehicle type based on the first deep learning model.

20. The device of claim 19, wherein providing the deep learning model further includes providing a second deep learning model to which a second new layer specialized for a second vehicle type different from the first vehicle type is added through the pre-trained model-based transfer learning, and
wherein predicting the motor-specific noise further includes predicting the motor-specific noise of a vehicle corresponding to the second vehicle type based on the second deep learning model.
